(19) United States
(12) Patent Application Publication
(10) Pub. No.: US 2009/0080221 A1
(43) Pub. Date: Mar. 26, 2009

(54) LIGHT RECEIVING ELEMENT

(76) Inventor: HIROAKI CHIDA, Tokyo (JP)

Correspondence Address: NEC CORPORATION OF AMERICA, 6535 N. STATE HWY 161, IRVING, TX, 75039, US

(21) Appl. No.: 12/211,278

(22) Filed: Sep. 16, 2008

(30) Foreign Application Priority Data
Sep. 21, 2007 (JP) 245660/2007

(51) Int. Cl. F21V 8/00

(52) U.S. Cl. 362/623

(57) ABSTRACT

An exemplary aspect of the invention is a light receiving element comprising a substrate, a light receiver absorbing light on a surface of the substrate, and a reflector reflecting the light incoming from a side of the substrate to the light receiver, wherein a reflecting surface of the reflector is inclined toward the side of the substrate in a section parallel to the surface of the substrate.

This application is based upon and claims the benefit of priority from Japanese Patent Application No. 2007-245660 filed on Sep. 21, 2007, the content of which are incorporated by reference.

### BACKGROUND ART

1. Technical Field

The present invention relates to an edge illuminated type light receiving element.

2. Description of the Related Art

With the advancement of technology in recent years, edge illuminated type light receiving elements having various reflection structures have been developed. For example, a combination use of an edge illuminated type light receiving element with a planner lightwave circuit is disclosed in a Non-Patent Document in URL: http://www.kyosemi.co.jp/product/data/ja2/KPE12GC.html, “Optical Communication Component,” [online], by Kyosemi Corporation (search date: Sep. 10, 2007). Specifically, the Non-Patent Document describes an edge illuminated type light receiving element having a structure in which light enters an edge surface perpendicular to a substrate, and then is upwardly reflected in a direction of a surface of the substrate by a reflective mirror formed by etching the substrate and is thereafter received by an absorbing layer on the surface thereof.

In the case of the technique described in the Non-Patent Document, however, the amount of reflection becomes the maximum in the optical arrangement that achieves the maximum light receiving sensitivity. Accordingly, the technique described in the Non-Patent Document is not preferable for an element to be used in an optical communication module since it is difficult to achieve both a sufficient light receiving sensitivity and low reflection characteristics. In particular, in the case of directly mounting the light receiving element on a planner lightwave circuit using an Si substrate, and detecting light outputted from an optical waveguide of an optical circuit, the light incident edge surface of the light receiving element needs to be inclined toward the optical axis in order to sufficiently reduce the amount of light returning to the optical waveguide. In this case, an edge portion of the optical waveguide cannot be in close contact with the light incident edge surface of the light receiving element, so that the light receiving efficiency of the element degrades to a large extent.

### SUMMARY OF THE INVENTION

An exemplary object of the present invention is to obtain an edge illuminated type light receiving element having a high light receiving sensitivity and low reflection characteristics by optimizing the arrangement of a reflective mirror formed at a back surface side of the light receiving element.

An exemplary aspect of the present invention is a light receiving element comprising a substrate, a light receiver absorbing light on a surface of the substrate, and a reflector reflecting the light incoming from a side of the substrate to the light receiver, wherein a reflecting surface of the reflector is inclined toward the side of the substrate in a section parallel to the surface of the substrate.

### BRIEF DESCRIPTION OF THE DRAWINGS

The above and other objects, features and advantages of the present invention will become more apparent from the following detailed description when taken in conjunction with the accompanying drawings wherein:

FIG. 1 is a diagram showing a perspective view of a low-reflection edge illuminated type light receiving element according to a first exemplary embodiment;

FIG. 2 is a diagram showing another perspective view of the low-reflection edge illuminated type light receiving element according to the first exemplary embodiment when viewed from another angle;

FIG. 3 is a cross sectional view of the low-reflection edge illuminated type light receiving element according to the first exemplary embodiment; and

FIG. 4 is a diagram showing a top view of the bottom surface of the low-reflection edge illuminated type light receiving element according to the first exemplary embodiment.

### EXEMPLARY EMBODIMENTS

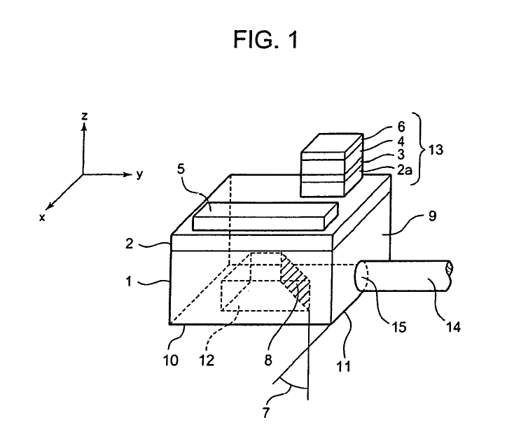

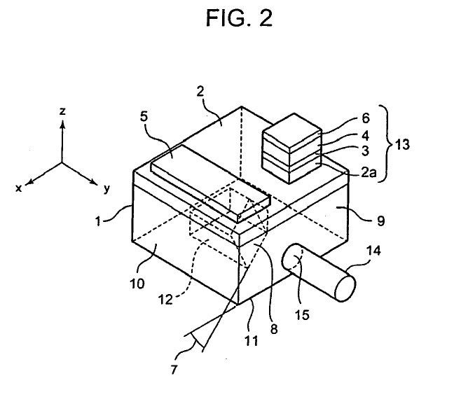

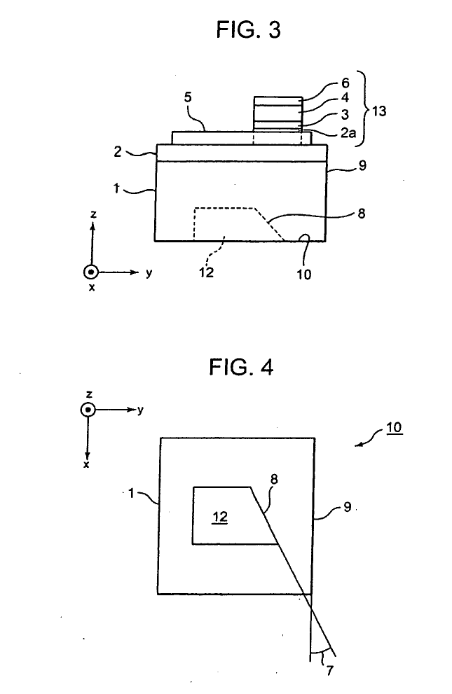

Next, a description will be given of a first exemplary embodiment of the present invention with reference to the drawings. FIG. 1 is a diagram showing a schematic perspective view of a low-reflection edge illuminated type light receiving element according to the first exemplary embodiment. FIG. 2 is a diagram showing another perspective view of the low-reflection edge illuminated type light receiving element according to the first exemplary embodiment when viewed from another angle. FIG. 3 is a cross sectional view of the low-reflection edge illuminated type light receiving element according to the first exemplary embodiment when viewed from a side surface. FIG. 4 is a diagram showing a plan view thereof when the bottom surface of a substrate is viewed from above.

### 1. First Exemplary Embodiment

An n-type cladding layer 2 having a composition of Inx1Ga (1-x1) Asy1P (1-y1) is disposed on the top surface of an n-type InP substrate 1. This n-type cladding layer 2 has an n-type cladding layer 2a protruding in a mesa type structure on a predetermined region of the top surface of the n-type cladding layer 2. On the top surface of the n-type cladding layer 2a, an optical absorption layer 3 of a pure semiconductor having a composition of Inx2Ga (1-x2) Asy2P (1-y2) is disposed. On the top surface of the optical absorption layer 3, a p+ type cladding layer 4 having a composition of, Inx3Ga (1-x3) Asy3P (1-y3) is disposed. An electrode 6 is disposed on the top surface of the p+ type cladding layer 4. An electrode 5 is disposed on a region of the top surface of the n-type cladding layer 2, the region being different from the region on which the n-type cladding layer 2a is disposed. The n-type cladding layer 2a, the optical absorption layer 3, the p+ type cladding layer 4 and the electrode 6 form a light receiver 13. The top surface of the n-type cladding layer 2 excluding the regions where the light receiver 13 and the electrode 5 are disposed is covered by a protection film of SiO2 or the like (not shown).

Among side surfaces perpendicular to the top surface of the substrate 1, one surface is defined as a light incident edge surface 9. The substrate 1 has an opening 12 that opens towards a bottom surface 10, which is the surface opposite to the top surface. A reflective mirror 8 is arranged on a surface of the opening 12, the surface being near the light incident edge surface 9. In addition, the reflective mirror 8 reflects light in a direction to the light receiver 13, the light having entered to the substrate 1 in a perpendicular direction with respect to the light entering surface 9.

The reflective surface of the reflective mirror 8 is inclined with respect to the light incident edge surface 9 in a cross section in parallel with the top surface of the substrate 1. For example, on the bottom surface 10 in parallel with the top surface of the substrate 1, the edge on the bottom surface side of the reflective surface of the reflective mirror 8 and an edge 11 of the bottom surface side of the light incident edge surface 9 are arranged so as to form an angle 7 greater than zero degree. The angle 7 is preferably not less than 5 degrees.

The light receiving element of the first exemplary embodiment is arranged so as to be optically coupled with an optical waveguide of a planner lightwave circuit. In FIGS. 1 and 2, an optical waveguide 14 coupled with the light receiving element is shown. An edge portion 15, through which light of the optical waveguide 14 is outputted, is assumed to include a cross section perpendicular to the optical waveguide 14. The light receiving element is arranged in a manner that the light incident edge surface 9 can be in close contact with the edge portion 15. A high light receiving sensitivity can be obtained by causing the edge portion 15 and the light incident edge surface 9 to be in close contact with each other. Light enters from the light incident edge surface 9. The incident light is reflected by the reflective mirror 8 in the direction of the light receiver 13. A part of the light entered in the light receiver 13 becomes light that returns to the optical waveguide 14 via the reflective mirror 8. However, because of the presence of the angle 7, the amount of light that returns to the optical waveguide 14 is reduced. Thus, low reflection characteristics can be obtained.

The light receiving element of the first exemplary embodiment is manufactured in the following manner. The n-type cladding layer 2 is formed on the substrate 1 by use of a crystal growth method such as Metal-Organic Vapor Phase Epitaxy (MOVPE) or Molecular Beam Epitaxy (MBE). Then, the optical absorption layer 3 is formed, and the p+ type cladding layer 4 is formed finally. A light receiving region is formed on the n-type cladding layer 2a by masking a predetermined region and performing etching up to a middle of the n-type cladding layer 2. The electrode 5 on the top surface of the n-type cladding layer 2 and the electrode 6 on the top surface of the p+ type cladding layer 4 are formed. By chemical etching, formed is the reflective mirror 8 having the edge on the bottom surface of the element that forms the angle 7 not less than five degrees with the edge between the light incident edge surface 9 and the bottom surface 10 at the bottom surface of the element.

### 2. Second Exemplary Embodiment

Hereinafter, means for solving the problems will be described by use of the reference numerals used in “EXEMPLARY EMBODIMENTS” with parentheses. These reference numerals are added for clarifying correspondences of the description in “What is claimed is” and the description in “EXEMPLARY EMBODIMENTS.” However, these reference numerals should not be used for interpretation of the technical scope of the present invention described in “What is claimed is.”

The light receiving element according to the present invention includes a substrate (1), a light receiver (13) that is formed on the top surface of the substrate and absorbs light, and a reflector (8) that reflects light in a direction of the light receiver, the light being entered from a side surface (9) of the substrate. In a cross section (10) in parallel with the top surface of the substrate, a reflective surface of the reflector (8) is inclined with respect to the side surface (9).

According to the present invention, by a reflector configured to include an angle with respect to a side surface through which light enters, a difference between a light incident arrangement that maximizes a light receiving sensitivity and a light incident arrangement that maximizes the amount of light that is reflected and returns to the light source can be increased. As a result, a trade-off between a high light receiving sensitivity and low reflection characteristics can be prevented, and an edge illuminated type light receiving element having a high light receiving sensitivity and low reflection characteristics can be obtained.

In particular, in a case where the edge illuminated type light receiving element is used in combination with a planner lightwave circuit, the low reflection characteristics can be maintained even if the edge surface of the light receiving element is arranged and used in close contact with an edge portion of a light waveguide of the planner lightwave circuit. Accordingly, desired light receiving sensitivity characteristics can be easily achieved.

Moreover, the light receiving element can be arranged immediately after the backward edge surface of a semiconductor laser as an optical output monitor of the semiconductor laser, and achieve a high light receiving efficiency and low reflection characteristics by optimizing the arrangements of the reflective mirror and the light receiver with respect to the arrangement in which the light receiving surface of the element is inclined with respect to the optical axis.

According to the aforementioned light receiving element, without using an additional component such as a light receiving element installation component, a reflective mirror or a lens, a light receiving element that can achieve both a high light receiving efficiency and low reflection characteristics can be provided for a high performance optical module that requires both a high light receiving efficiency and low reflection characteristics.

As an application example of the present invention, optical detection by a wavelength variable laser using a planner lightwave circuit, a dispersion correction transmitter and a delay detection receiver can be cited.

The previous description of these embodiments is provided to enable a person skilled in the art to make and use the present invention. Moreover, various modifications to the embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

What is claimed is:

1. A light receiving element comprising:
a substrate;
a light receiver absorbing light on a surface of the substrate; and
a reflector reflecting the light incoming from a side of the substrate to the light receiver,
wherein a reflecting surface of the reflector is inclined toward the side of the substrate in a section parallel to the surface of the substrate.

2. The light receiving element according to claim 1, wherein the reflecting surface is inclined at an angle of approximately 5 degrees or more.

3. The light receiving element according to claim 1, wherein the light enters from an optical waveguide in close contact with the side of the substrate.

4. A light receiving method comprising:
reflecting incoming light from a side of a substrate to a surface of the substrate on a reflecting surface which is inclined toward the side of the substrate in a section parallel to the surface of the substrate; and
absorbing the light on the surface of the substrate.
